(19) United States
(12) Patent Application Publication
(10) Pub. No.: US 2024/0353556 A1
(43) Pub. Date: Oct. 24, 2024

(54) AUGMENTING COMMUNICATION SIGNAL MEASUREMENT WITH ENVIRONMENTAL INFORMATION RELATIVE TO A COMMUNICATION DEVICE

(71) Applicant: Telefonaktiebolaget LM Ericsson (publ), Stockholm (SE)

(72) Inventors: Athanasios KARAPANTELAKIS, Solna (SE); Kaushik DEY, Kolkata (IN); Lackis ELEFTHERIADIS, Valbo (SE); Pedro BATISTA, Sollentuna (SE); Konstantinos VANDIKAS, Solna (SE); Aneta VULGARAKIS FELJAN, Stockholm (SE); Maxim TESLENKO, Sollentuna (SE)

(21) Appl. No.: 18/682,734

(22) PCT Filed: Aug. 9, 2021
(86) PCT No.: PCT/EP2021/072147

§ 371 Date: Feb. 9, 2024

(51) Int. Cl. G01S 13/89; H04L 5/00; H04W 64/00

(52) U.S. Cl. CPC G01S 13/89; H04L 5/0048; H04W 64/006

(57) ABSTRACT

A method performed by a communication device in a communication network for augmenting a communication signal message with environmental information relative to the communication device is provided. The method includes performing a first reference signal measurement. The method further includes, responsive to the performing, detecting a plurality of objects in an area proximate the communication device; and generating information about the detected plurality of objects. The method further includes extracting, from the generated information, the environmental information including an environmental description information and a position description information for the plurality of objects relative to the communication device. The method further includes signalling to the network node the communication signal message including the first reference signal measurement, at least some information from the environmental description information regarding the plurality of objects in an area proximate the communication device, and the position description information.

### TECHNICAL FIELD

The present disclosure relates generally to methods for augmenting a communication signal message with environmental information relative to a communication device, and related methods and apparatuses.

### BACKGROUND

Reference signal measurements provide information on the signal level and quality in third generation partnership project (3GPP) networks. In fourth and fifth generation of mobile networks (4G and 5G, respectively), such measurements are reported at the physical layer (layer 1) and at the radio resource control layer (layer 3), from a mobile device (also referred to herein as a User Equipment, UE, or communication device)) towards a radio base station (e.g., evolved-NodeB or eNB in 4G and g-NodeB or gNB in 5G). Typical metrics used are Reference Signal Received Power (RSRP), Reference Signal Received Quality (RSRQ). The former measures the signal level the average power received from a single reference signal, transmitted on the “downlink” (DL) interface from the eNB/gNB towards the UE. The latter measures the signal quality, and it indicates the ratio of carrier power to interference power (i.e., a signal to noise ratio). Together, RSRP and RSRQ are used to assess the signal strength of a cell network for a specific UE. Typically, RSRQ is used as a complement to RSRP: If RSRP values are similar, then RSRQ is used to indicate which connection is better.

Reference signals can be used in two main scenarios.

In a first scenario, as a layer 3 measurement at the radio resource control (RRC) layer, reference signals are used during handover procedure. A UE periodically or on request from the radio base station, reports through an RRC Measurement Report message the RSRP for reference signals received from a serving cell and neighboring cells. If RSRP is consistently better for a neighboring cell when compared to the serving cell, the serving cell may initiate the handover procedure towards the neighboring cell.

In a second scenario, as a layer 1 measurement during a beam management procedure in beamforming. Beamforming is a signal processing technology that enables an antenna array, that is part of a 5G radio base station (also referred to as g-Node B or gNB) to transmit radio signals to specific directions rather than broadcasting the signal in all directions. By focusing beams on the mobile devices, beamforming reduces the signal to noise ratio, and mobile devices receive stronger and clearer signals. By implication, beamforming also benefits Quality of Service (Qos). For example, throughput and latency may be improved. In order to discover a new UE in the area, a beamforming manager (BIM) periodically or on request instructs the antenna to perform a beam sweep, wherein the array transmits all beams in predefined directions in a burst. Technically, this process involves the following steps.

Step P1: Transmission from gNB synchronization signal blocks (SSBs), one for every beam. A UE receiving those beams detects the best beam by evaluating the quality of the reference signal for each of the received beams. The UE measures the power of the received reference signals and reports to the gNB the beam with the highest received power (RSRP). This is done using a wide receiver (Rx) beam on the UE. Specifically, the metrics measured are SS-RSRP (Reference Signals Received Power), SS-RSRQ (Reference Signal Received Quality) and SS-SINR (signal-to-interference-plus-noise ratio). FIG. 2 is a table illustrating a table of signal quality metrics for various radio frequency (RF) conditions.

Step P2: The gNB performs beam refinement using channel state information reference signal (CSI-RS) transmissions in approximate location of the widebeam reported by UE in P1. The UE then measures RSRP on all beams and selects the best beam as the one with the highest RSRP.

Step P3: In step P3, gNB aims to select the best received beam based on RSRP measurements of all received beams.

There currently exist certain challenges. Current solutions for measuring signal level and quality are based on a UE assessment of a received reference signal from a radio base station (eNB/gNB). Although such reports may indicate the existing quality of the network connection, they do not reveal the reason why the network connection is of poor quality.

### SUMMARY

Certain aspects of the disclosure and their embodiments may provide solutions to these or other challenges.

Various embodiments of the present disclosure, leverage capabilities of a UE to sense (also referred to herein as “detect”) its surroundings to determine the distance of objects in the surroundings from a radio base station (e.g., an eNB/gNB) and create a description of the surrounding environment. Positioning and environmental description information augments existing reference signal measurements and allows the radio base station to construct a composite description of the environment within range. In some embodiments, the composite description is a material map that includes signal degradation in radio base stations. In some embodiments, machine learning (ML) is used in order to predict a UE's mobility pattern based on historical mobility patterns. In some embodiments, the predicted mobility pattern together with the composite description of the environment and UE location is used by a radio base station in order to make a decision (which may be a more informed decision) on which neighboring cell to handover a UE to, or what beam to allocate in a beam selection.

Certain embodiments may provide one or more of the following technical advantages. By augmenting reference signal measurements with positioning and environmental description information, and the radio base station generation a composite description of the surrounding environment, an improved decision-making in processes involving reference signal measurements may result, such as handover and beamforming management decisions. Various embodiments may also provide an additional technical advantage in that various embodiments may use existing, standardized communication protocols.

In various embodiments, a method performed by a communication device in a communication network for augmenting a communication signal message with environmental information relative to the communication device is provided. The method includes performing a first reference signal measurement of a reference signal received from a network node. The method further includes, responsive to the performing, detecting a plurality of objects in an area proximate the communication device. The method further includes generating information about the detected plurality of objects. The method further includes extracting, from the generated information, the environmental information comprising an environmental description information for the plurality of objects and a position description information for the plurality of objects relative to the communication device. The method further includes signalling to the network node the communication signal message comprising the first reference signal measurement, at least some information from the environmental description information regarding the plurality of objects in an area proximate the communication device, and the position description information.

In some embodiments, the method further includes determining, based on a privacy parameter, to omit signalling to the network node at least some information from the environmental description information and the position description information in the communication signal message that includes the first reference signal measurement.

In some embodiments, the method further includes performing a second reference signal measurement of a second reference signal received from the network node; and determining that the environmental description information and the position description information are unchanged from a time of the extracting.

In some embodiments, the method further includes signalling a second communication signal message including the second reference signal measurement to the network node, and the second communication signal message omitting the environmental description information and the position description information.

In some embodiments, the method further includes determining, based on a privacy parameter, to omit signalling to the network node the environmental description information and the position description information in the second communication signal message that includes the second reference signal measurement.

In other embodiments, a communication device in a communication network for augmenting a communication signal message with environmental information relative to the communication device is provided. The communication device includes at least one processor; and at least one memory connected to the at least one processor and storing program code that is executed by the at least one processor to perform operations including perform a first reference signal measurement of a reference signal received from a network node. The operations further include, responsive to the perform, detect a plurality of objects in an area proximate the communication device. The operations further include generate information about the detected plurality of objects. The operations further include extract, from the generated information, the environment information comprising an environmental description information for the plurality of objects and a position description information for the plurality of objects relative to the communication device. The operations further include signal to the network node the communication signal message comprising the first reference signal measurement, at least some information from the environmental description information regarding the plurality of objects in an area proximate the communication device, and the position description information.

In other embodiments, a communication device in a communication network for augmenting a communication signal message with environmental information relative to the communication device is provided. The communication device adapted to perform operations including perform a first reference signal measurement of a reference signal received from a network node. The operations further include, responsive to the perform, detect a plurality of objects in an area proximate the communication device. The operations further include generate information about the detected plurality of objects. The operations further include extract, from the generated information, the environment information comprising an environmental description information for the plurality of objects and a position description information for the plurality of objects relative to the communication device. The operations further include signal to the network node the communication signal message comprising the first reference signal measurement, at least some information from the environmental description information regarding the plurality of objects in an area proximate the communication device, and the position description information.

In other embodiments, a computer program comprising program code to be executed by processing circuitry of a communication device is provided, whereby execution of the program code causes the communication device to perform operations comprising perform a first reference signal measurement of a reference signal received from a network node. The operations further include, responsive to the perform, detect a plurality of objects in an area proximate the communication device. The operations further include generate information about the detected plurality of objects. The operations further include extract, from the generated information, the environment information comprising an environmental description information for the plurality of objects and a position description information for the plurality of objects relative to the communication device. The operations further include signal to the network node the communication signal message comprising the first reference signal measurement, at least some information from the environmental description information regarding the plurality of objects in an area proximate the communication device, and the position description information.

In other embodiments, a computer program product comprising a non-transitory storage medium including program code to be executed by processing circuitry of a communication device is provided, whereby execution of the program code causes the communication device to perform operations comprising perform a first reference signal measurement of a reference signal received from a network node. The operations further include, responsive to the perform, detect a plurality of objects in an area proximate the communication device. The operations further include generate information about the detected plurality of objects. The operations further include extract, from the generated information, the environment information comprising an environmental description information for the plurality of objects and a position description information for the plurality of objects relative to the communication device. The operations further include signal to the network node the communication signal message comprising the first reference signal measurement, at least some information from the environmental description information regarding the plurality of objects in an area proximate the communication device, and the position description information.

In other embodiments, a method performed by a network node in a communication network for generating an update to a composite description of an environment proximate a communication device is provided. The method includes signalling a reference signal to the communication device. The method further includes receiving, from the communication device, information in a communication signal message. The information includes a reference signal measurement from the reference signal, at least some information regarding a plurality of objects in an area proximate the communication device, and a position description information for the plurality of objects in the area proximate the communication device. The method further includes generating the update to the composite description in a database communicatively connected to the network node based on the information in the message. The composite description includes a representation containing information about a size, a shape, a signal absorption metric, and a location of each object in the plurality of objects.

In some embodiments, the method further includes storing the updated composite description in the database when the object is not already included in the database.

In some embodiments the method further includes determining a mobility trajectory of the communication device, the determining based on an output from a machine learning model that uses a plurality of historical mobility patterns of the communication device as input to the machine learning model; and deciding an action by the network node based on the determined mobility trajectory, the composite description, and the reference signal measurement.

In some embodiments, the method further includes executing the action.

In other embodiments, a network node in a communication network for generating an update to a composite description of an environment proximate a communication device is provided. The network node includes at least one processor; and at least one memory connected to the at least one processor and storing program code that is executed by the at least one processor to perform operations comprising signal a reference signal to the communication device. The operations further include receive, from the communication device, information in a communication signal message, the information comprising a reference signal measurement from the reference signal, at least some information regarding a plurality of objects in an area proximate the communication device, and a position description information for the plurality of objects in the area proximate the communication device. The operations further include generate the update to the composite description in a database communicatively connected to the network node based on the information in the message, the composite description comprising a representation containing information about a size, a shape, a signal absorption metric, and a location of each object in the plurality of objects.

In other embodiments, a network node in a communication network for generating an update to a composite description of an environment proximate a communication device is provided. The network node adapted to perform operations comprising: signal a reference signal to the communication device. The operations further include receive, from the communication device, information in a communication signal message, the information comprising a reference signal measurement from the reference signal, at least some information regarding a plurality of objects in an area proximate the communication device, and a position description information for the plurality of objects in the area proximate the communication device. The operations further include generate the update to the composite description in a database communicatively connected to the network node based on the information in the message, the composite description comprising a representation containing information about a size, a shape, a signal absorption metric, and a location of each object in the plurality of objects.

In other embodiments, a computer program comprising program code to be executed by processing circuitry of a network node is provided, whereby execution of the program code causes the network node to perform operations comprising signal a reference signal to the communication device. The operations further include receive, from the communication device, information in a communication signal message, the information comprising a reference signal measurement from the reference signal, at least some information regarding a plurality of objects in an area proximate the communication device, and a position description information for the plurality of objects in the area proximate the communication device. The operations further include generate the update to the composite description in a database communicatively connected to the network node based on the information in the message, the composite description comprising a representation containing information about a size, a shape, a signal absorption metric, and a location of each object in the plurality of objects.

In other embodiments, a computer program product comprising a non-transitory storage medium including program code to be executed by processing circuitry (1203) of a network node (103, 1200) is provided, whereby execution of the program code causes the network node to perform operations comprising signal a reference signal to the communication device. The operations further include receive, from the communication device, information in a communication signal message, the information comprising a reference signal measurement from the reference signal, at least some information regarding a plurality of objects in an area proximate the communication device, and a position description information for the plurality of objects in the area proximate the communication device. The operations further include generate the update to the composite description in a database communicatively connected to the network node based on the information in the message, the composite description comprising a representation containing information about a size, a shape, a signal absorption metric, and a location of each object in the plurality of objects.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates example embodiments of components in a communication network for creating a composite description in accordance with some embodiments of the present disclosure;

FIG. 2 is a table illustrating a table of signal quality metrics;

FIG. 3 is a table illustrating examples of degradation of signal quality based on material between a network node and a communication device;

FIG. 4 illustrates an example embodiment of a three-dimensional (3D) model of a space with annotations resulting from a 3D object detection algorithm overlayed on detected objects in accordance with some embodiments of the present disclosure;

FIG. 5 illustrates a signalling diagram for creating a composite description in the form of a material map with annotations in accordance with some embodiments of the present disclosure;

FIG. 6 illustrates an example table of detected objects and location/distance relative to a communication device's position in accordance with some embodiments of the present disclosure;

FIG. 7 illustrates an example embodiment of sound localization using a network node as a sound emitter at a subsonic or supersonic level and a communication device having two microphones in accordance with some embodiments of the present disclosure;

FIG. 8 is an example embodiment of a symbolic representation in the form of a graph for the objects included in the table of FIG. 6, in accordance with some embodiments of the present disclosure;

FIG. 9 illustrates a signalling diagram for handover based on reference signal measurements and a materials map, in accordance with some embodiments of the present disclosure;

FIG. 10 illustrates a signalling diagram for beam selection based on reference signal measurements and materials maps, in accordance with some embodiments of the present disclosure;

FIG. 11 is a block diagram illustrating a communication device (e.g., a mobile device or user equipment, UE) according to some embodiments of the present disclosure;

FIG. 12 is a block diagram illustrating a network node (e.g., a radio base station, eNB/gNB) according to some embodiments of the present disclosure;

FIG. 13 is a block diagram illustrating a core network CN node (e.g., an AMF node, an SMF node, etc.) according to some embodiments of the present disclosure;

FIGS. 14 and 15 are flow charts illustrating operations of a communication device according to some embodiments of the present;

FIGS. 16 and 17 are flow charts illustrating operations of a network node according to some embodiments of the present disclosure;

FIG. 18 is a block diagram of a communication system in accordance with some embodiments of the present disclosure;

FIG. 19 is a block diagram of a user equipment in accordance with some embodiments of the present disclosure;

FIG. 20 is a block diagram of a network node in accordance with some embodiments of the present disclosure;

FIG. 21 is a block diagram of a host computer communicating with a user equipment in accordance with some embodiments of the present disclosure; and

FIG. 22 is a block diagram of a virtualization environment in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As discussed above, current solutions for measuring signal level and quality are based on a UE assessment of a received reference signal from a radio base station (e.g., an eNB/gNB). Although such reports may indicate the existing quality of the network connection, they do not reveal the reason why the network connection is of poor quality.

FIG. 3 is a table illustrating examples of degradation of signal quality based on material between a network node and a communication device that may cause poor reception (source: https://www.wilsonamplifiers.com/blog/11-major-building-materials-that-kill-your-cell-phone-reception/).

A problem of poor or reduced reception may arise when a UE is mobile in complex environments, such as cities, where the line of sight (LoS) between the UE and the radio base station is obstructed by different environmental phenomena and/or different materials at different points in time. In such environments, a reference signal measurement may not be enough to make a good or more informed decision (e.g., beam selection or handover), as it may change frequently, depending on the type of material obstructing the UE LoS.

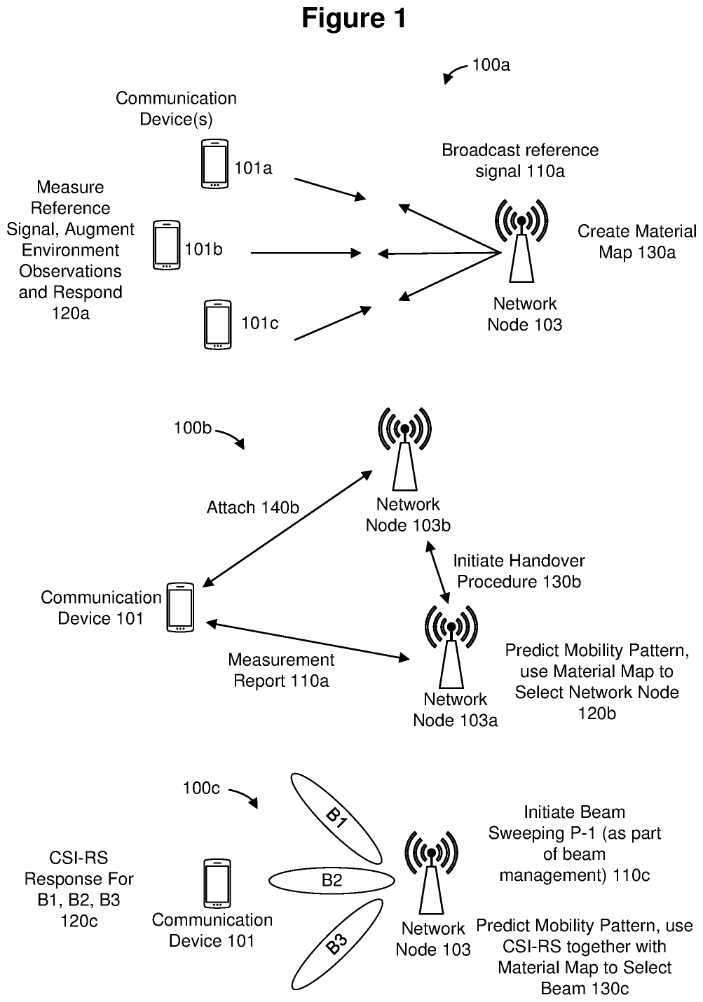

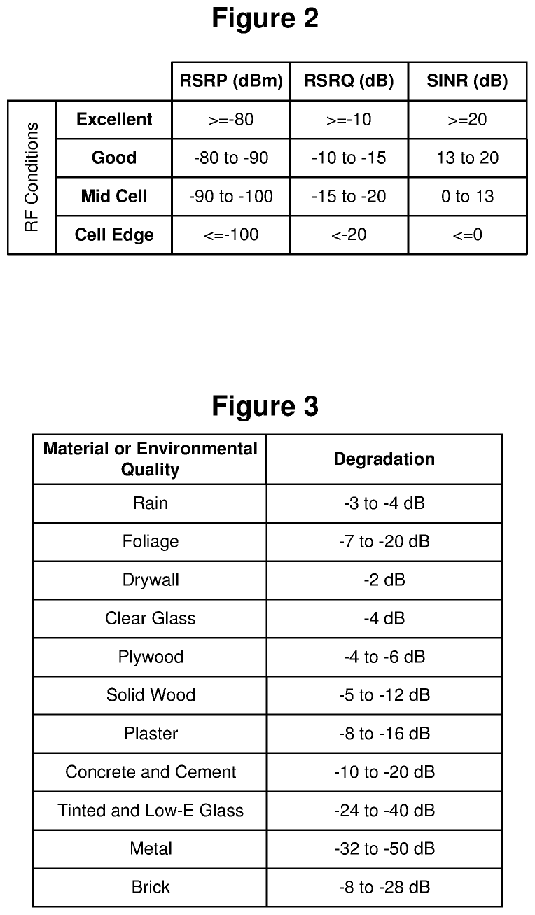

FIG. 1 illustrates example embodiments of components in a communication network for creating a composite description in accordance with some embodiments of the present disclosure.

Referring first to the schematic diagram 100a, components are illustrated for creating a composite description (e.g., a material map or a spatial map). Network node 103 (e.g., an eNB/gNB) broadcasts reference signal 110a. At 120a, a communication device 101 (or a plurality of communication devices 101a, 101b, 101c, etc.) receive and measure the reference signal; make environmental observations and respond with the measured reference signal augmented with the environmental observations. At 130a, network node 103 creates a material map.

Referring next to the schematic diagram 100b, components are illustrated for using a composite description for selecting a handover target cell. At 110a, communication device 101 measures a reference signal received from network node 103a; makes environmental observations and responds with the measured reference signal augmented with the environmental observations. As described further herein, network node 103a may create or update a composite description from the response of communication device 101. In some embodiments, at 120b, network node 103a predicts a mobility pattern of communication device 101 and uses the composite description to select a network node for a handover, illustrated as network node 103b. At 130b, network node 103a initiates a handover procedure to network node 130b. At 140b, communication device 101 attaches to network node 103b.

Referring now to the schematic diagram 100c, components are illustrated for using a composite description for selecting a beam. At 110c, network node 103 initiates a beam sweeping procedure (e.g., beam sweeping step P-1 described herein) as part of beam management. Network node 103 performs beam refinement using channel state information reference signal (CSI-RS) transmissions in an approximate location of a widebeam reported by UE in step P-1. At 120c, in response to the CSI-RS, communication device 101 measures RSRP on all beams (illustrated as beams B1, B2, and B3) and signals a response to network node 103. At 130c, network node 103 predicts a mobility pattern of communication device 101 and uses the CSI-RS response together with the composite description to select a beam (e.g., from beams B1, B2, and B3).

Various embodiments of the present disclosure include the following components.

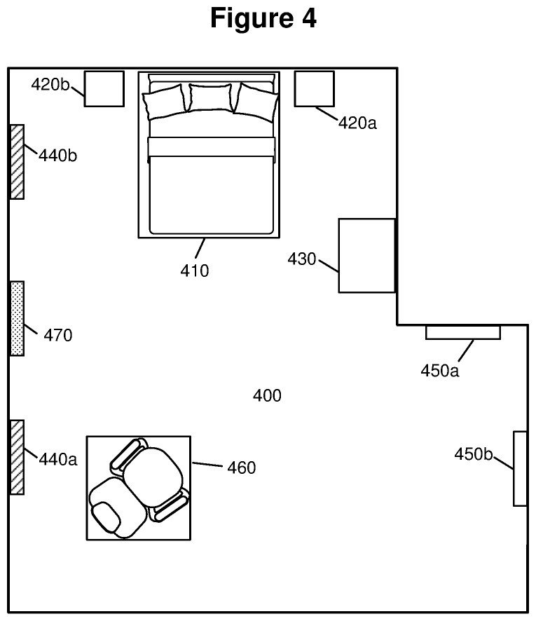

A mobile device that is capable of sensing/detecting its surroundings in terms of shapes and material composition in addition to having a radio. For example, and without limitation, the mobile device can use a light detection and ranging (LIDAR) equipment and 2D camera to create a digital three-dimensional representation of the space the mobile device is in, and visual object detection to identify the objects in that space. FIG. 4 illustrates an example embodiment of a 3D model of a space 400 with annotations resulting from a 3D object detection algorithm overlayed on detected objects in accordance with some embodiments of the present disclosure. The annotations include: bed 410; tables 420a, 420b; cupboard 430; windows, 4401, 440b; doors 450a, 450b; chair 460; and painting 470.

In another embodiment that is less computationally expensive only a 2D camera is used to create a panorama view of the surroundings, then visual object detection is applied. In this embodiment, there may be a loss in granularity as the distance of the mobile device from the objects is not measured. Thus. the mobile device locates itself using either some satellite positioning technology (e.g., Global Positioning System-GPS) or using multiple microphones (as described further herein).

In FIG. 1, two logical functions are illustrated as being co-located with network node 103: a composite description component (e.g., a material map composition component) and a Mobility Prediction and Actuation component (MPA). In some embodiments, these two logical functions can be located outside of a radio base station (e.g., at an edge cloud, as part of a mobile operator's core network or hosted by a third-party cloud provider). As described further herein, the composite description component uses information provided from an individual communication device(s) (e.g., position and 3D model with augmented information as illustrated in FIG. 4), to construct the composite description (e.g., a material composition map) around the range of the cell. The (MPA) predicts a movement pattern of a communication device using historical measurements, as described further herein.

In some embodiments, these two logical functions are used to select a beam (e.g., the best beam) for a communication device (as described further herein) using not only reference signals, but also a material map and a projection of mobile trajectory.

In another embodiment, these two logical entities are used to select a network node (e.g., the best gNB/eNB) to handover a communication device to, out of a group of neighboring network nodes (as described further herein).

Composite description composition is now further described.

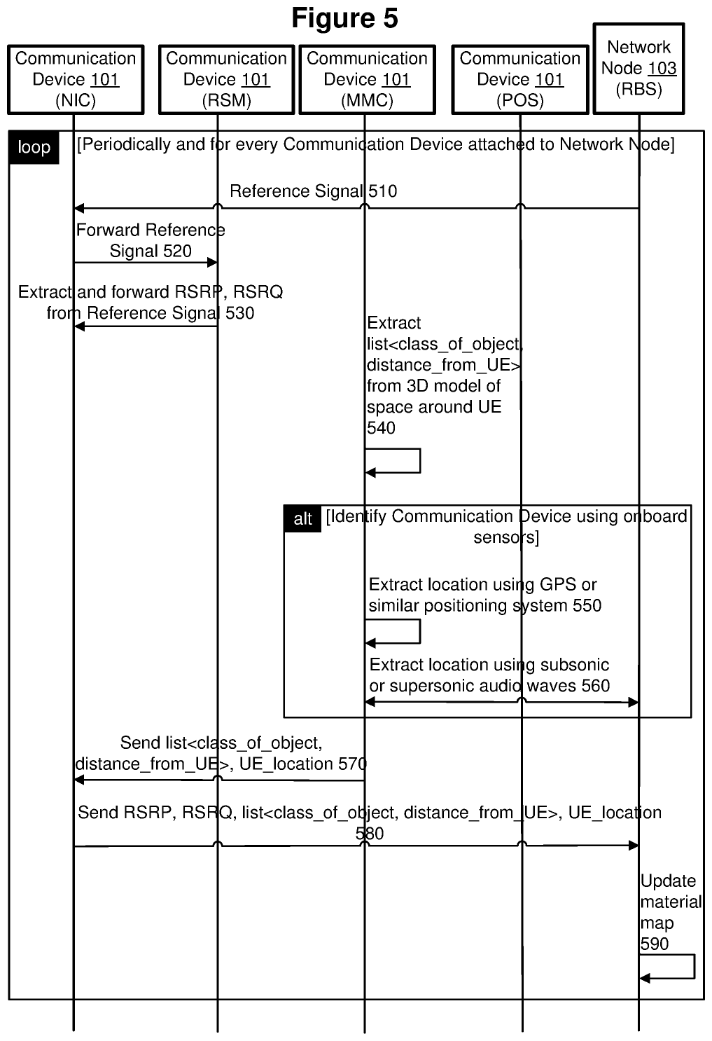

FIG. 5 illustrates a signalling diagram for creating a composite description in the form of a material map with annotations in accordance with some embodiments of the present disclosure. While FIG. 5 illustrates periodic reporting of detected information augmented to reference signal measurements, in other embodiments, the detected information is reported on demand (e.g., in handover this can be triggered by request of a radio base station using an RRC measurement control message).

Referring to FIG. 5, communication device 101 includes the following components: a network interface card (NIC) that receives and transmits messages via an antenna of communication device 101; a reference signal measurement (RSM) component that measures a reference signal using standard metrics (e.g., RSRP, RSRQ); a material map composition (MMC) that identifies shapes of materials and distances of communication device 101 to these materials; and a positioning component (POS) that identifies the communication device 101 location in relation to network node 103 (e.g., a eNB or a gNB depending on whether it is a 4G or a 5G network node). While FIG. 5 illustrates one communication device 101, a plurality of communication devices can be included that each include these components.

The operations of FIG. 5 are performed in loop periodically and for every communication device attached to network node 103. At operation 510, network node 103 signals a reference signal that is received at a NIC of communication device 101 via an antenna of communication device 101. For example, the reference signal typically is embedded in an RRC Connection Reconfiguration message. At operation 520, the NIC of communication device 101 forwards the received reference signal to the RSM component of communication device 101. The RSM, at operation 530, extracts and forwards a reference signal measure (e.g., RSRP/RSRQ from the reference signal) to the NIC of communication device 101. While this embodiment is described using a RSRP or RSRQ measurement, other metrics not illustrated in FIG. 5 may also be used (e.g., signal to noise ratio or SINR).

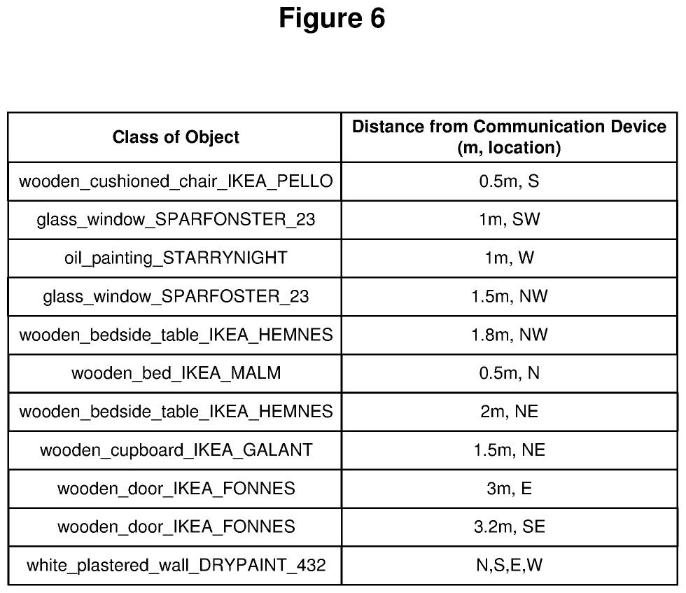

At operation 540, the communication device 101 has spatial awareness. For example, using a combination of LIDAR readings, camera and visual object detection, the communication device 101 detects a set of objects and their distance from communication device 101. The MMC of communication device 101 extracts a list relating to detected objects from a 3D model of space around communication device 101 including, e.g., a class for each object and a distance of each object from communication device 101. For example, referring to FIG. 4, and assuming communication device 101 is between chair 460 and table 420b, the information illustrated in FIG. 6 can be extracted. FIG. 6 illustrates an example table of detected objects and location/distance relative to a communication device's position in accordance with some embodiments of the present disclosure. As illustrated in FIG. 6, the extracted information includes a class of each object and a distance from communication device 100 (shown, e.g., in meters and geographical direction relative to communication device 101's current position).

In some embodiments, not all data for detected objects (e.g., from a point cloud) is transmitted, as the need for this data is to identify whether detected objects obstruct a Line of Sight towards network node 103. FIG. 6 illustrates a smaller representation of data where, given a capable detector, the classes of objects can be reduced to specific models (e.g., IKEA models). In addition to this list of classes, communication device 101 can determine its location, either using a built-in satellite positioning system (for example Global Positioning System or GPS) in operation 550, or by means of audio in operation 560.

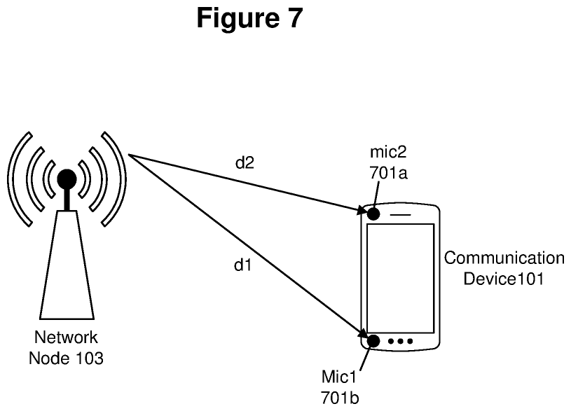

In an example embodiment of operation 560, an audio-based implementation uses two microphones 701a, 701b of communication device 101 for sound localization of a sound emitted by network node 103. FIG. 7 illustrates an example embodiment of sound localization using network node 103 as a sound emitter at a subsonic or supersonic level and communication device 101 having two microphones 701a, 701b as sound absorbers in accordance with some embodiments of the present disclosure. Referring to FIG. 7, once localizing the sound, distance d1, d2 from the sound source can be determined by measuring the decrease in intensity or decrease in sound pressure (see for example http://www.sengpielaudio.com/DecreaseInLevelOfSoundPressureAndSoundIntensity.pdf). In this embodiment, an antenna of network node 103 emits an audio reference signal with known pressure and intensity, and communication device 101 measures the pressure and intensity of the received reference signal and an interarrival time between the audio waves received by two microphones 701a, 701b. The interarrival time allows the communication device 101 to localize the direction of sound, while the measurements of pressure and intensity allow communication device 101 to determine the distance from the source. In some embodiments, communication device 101 measures some environmental effects such as rain, that may affect the quality of the signal.

Referring again to FIG. 5, at operation 570, the MMC sends to the NIC (1) the list that includes a class for each object and a distance of each object from communication device 101, and (2) the optional location of communication device 101, if generated. At operation 580, the NIC signals the list and location (if included) and the RSRP, RSRQ to network node 103.

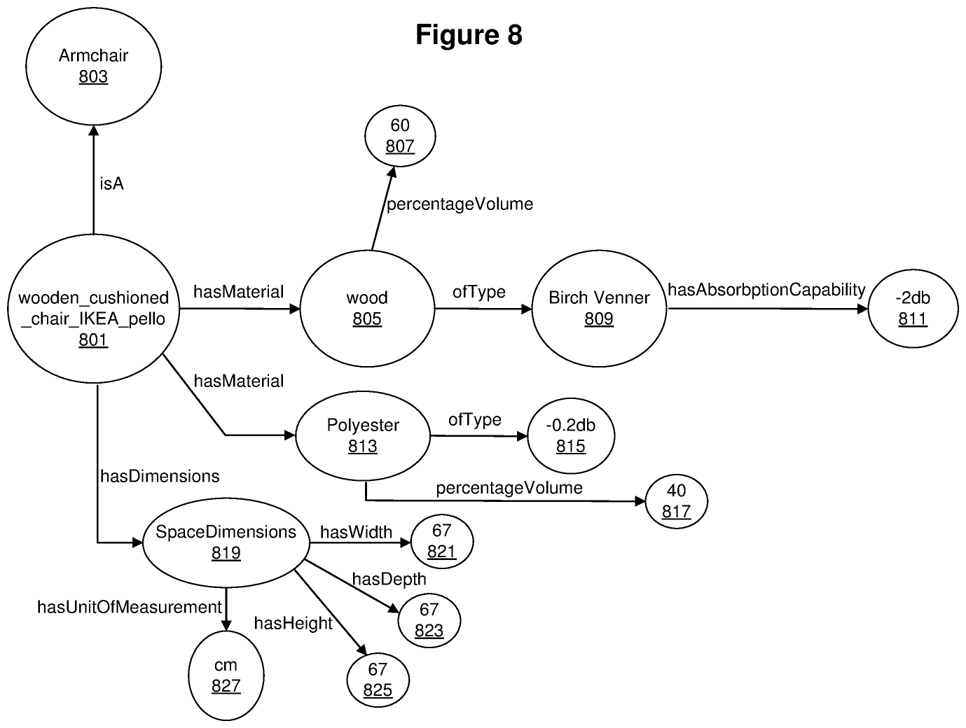

At operation 590, upon reception of the information from operation 580, network node 103 performs an update operation on its own database of materials in its range. Alternatively, the database of materials may by located at a node of the communication network communicatively connected to network node 103. The update operation includes two operations. A first operation uses a symbolic representation of the identified object, in order to determine the signal absorption properties of the object. FIG. 8 is an example embodiment of a symbolic representation in the form of a graph for the objects included in the table of FIG. 6, using existing metadata from a producer of the object (see e.g., https://www.ikea.gr/en/products/sofas-armchairs/armchairs/armchairs/pello-armchair/50078464/). The representation of FIG. 8 contains information about the shape (e.g., 803), materials (e.g., 805, 807, 809, 813, 817), and size (e.g., 819-827) of the object 801 (e.g., wooden_cushioned_chair_IKEA_pello), as well as its signal absorption qualities (e.g., 811, 815).

In some embodiments, the following algorithm is an example algorithm that can be used by network node 103 in order to extract the properties needed to construct/generate the representation of an object in the material map. Before the example algorithm is used, network node 103 received an update message from communication device 101 (e.g., message 580 in FIG. 5), that includes: UE_location, list<class_of_object_detected, euclidean_distance_of_object_from_UE, direction> (for more information on the list see discussion herein of the table of FIG. 6):

```
For currentObject in list:
  Calculate average signal absorption capability in db
  avgabs(currentObject)
    (weighted average by percentageVolume)
  Calculate occlusion quality (partial,full) based on object type
    occquality(currentObject)
  Retrieve dimensions dim(currentObject)={width(currentObject),
    depth(currentObject), height(currentObject) }
  Find location of the object loc(currentObject), using UE_location,
    euclidean_distance_of_object_from_UE, direction
  Store [loc(currentObject), dim(currentObject),occ_{quality},(currentObject),
    avg_{abs}(currentObject)] in material map
  End
```

While the example algorithm above includes finding a location of the object using a Euclidean distance of the object from the UE, other forms of distance may be used. Other forms of distance include, without limitation, haversine distance. See e.g., https://en.wikipedia.org/wiki/Haversine formula.

The example algorithm iterates through the list of objects. For every object, the algorithm initially calculates the object's signal absorption capability by multiplying the absorption capability of each material comprising the object by the percentage of volume that each material occupies within the object, then dividing by the number of materials. Next, the algorithm identifies the occlusion quality of the object. If the object is something massive such as a wall, then full occlusion quality is identified (e.g., “1”). On the other hand, if the object does not completely or nearly completely obstruct the signal, for example it is an armchair, then partial occlusion quality is identified (e.g., “0”).

In some embodiments, although not illustrated in FIG. 8, there can also be different grades of occlusion quality instead of a binary classification, that can be normalized between 1 and 0.

In some embodiments, the location of the object can be a literal location (e.g., the object's latitude and longitude) when a satellite positioning system such as GPS is used, or it can be a relative location (e.g., the object's distance and direction from the radio tower) when a relative location inferencing system is used such as the one described herein with reference to FIG. 7.

In some embodiments, network node 103 stores the location of the object (relative or literal), the dimensions of the object, the object's occlusion quality and the estimated signal absorption in its local database or a database communicatively connected to network node 103 (e.g., a “material map” database). In some embodiments, during the storage process, if the object has already been observed by another communication device, the object is not stored again. In some embodiments, an update operation can also happen wherein network node 103 refines a record in the database with an update (e.g., a better estimate of the object's actual location).

In some embodiments, communication device 101 can skip augmenting spatial/environment information to measurement response messages if the environment is unchanged as compared to a previous message. Additionally, augmentation of this spatial information can be blocked from the operator side (e.g., in terms of applying geofencing rules), and/or communication device 101 can “opt out” from sending this information in case of privacy concerns.

In another embodiment (not illustrated in FIG. 5), communication device 101 uses the symbolic graph of FIG. 8, and instead of sending a list<class_of_object_detected, euclidean_distance_of_object_from_UE, direction>, communication device 101 sends a list<dimensions, occlusion quality, euclidean_distance_of_object_from_UE, direction>, which may ensure more private communications as details about the detected objects are not revealed. In this embodiment, network node 103 merges this information together to create the material map without using the symbolic graph.

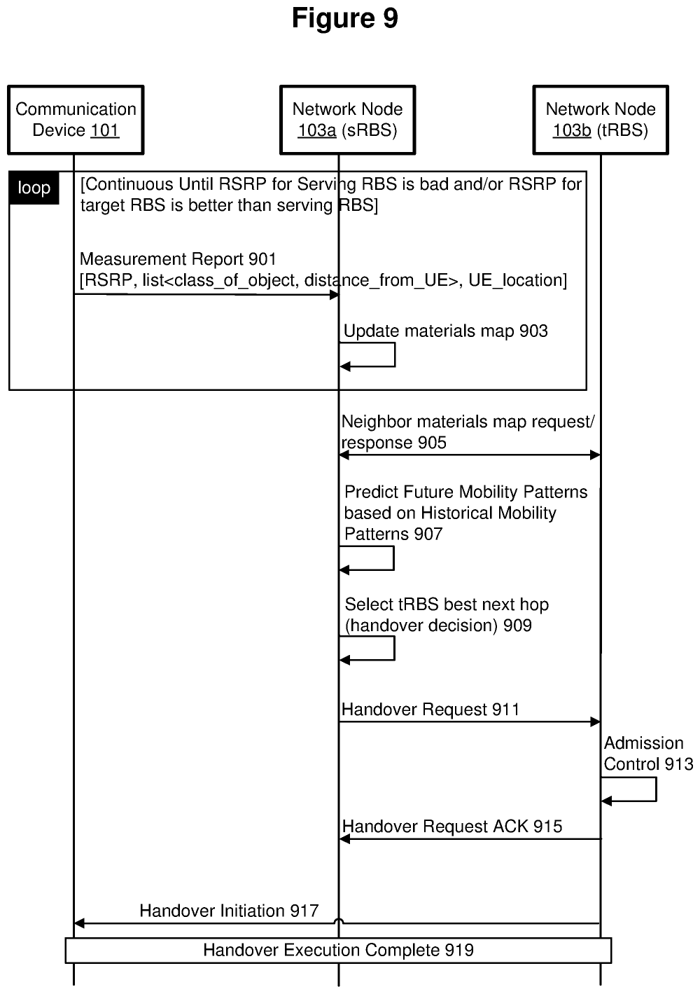

An example embodiment illustrating a handover process using a composite description (e.g., a material map) is now discussed. FIG. 9 illustrates a signalling diagram for handover based on reference signal measurements and a materials map, in accordance with some embodiments of the present disclosure. At operation 901, communication device 101 attached to serving network node 103a periodically or on-demand reports its reference signal measurement together with its assorted environment measurements discussed herein. As per standard 3GPP practice, reference signal measurements may also include measurements from other neighboring radio base stations. When network node 103a detects that the reference signal measurement of its own downlink signal from communication device 101 is poorer (e.g., much poorer) than that of at least one of its neighboring network nodes, then network node 103a determines that it is time to handover communication device 101 to another network node, known as target RBS (tRBS) shown as network node 103b. However, instead of solely relying on reference signal measurements, serving network node 103a uses communication device 101 location measurements as well as material maps from neighbors in order to make a decision of the neighboring network node to handover communication device 101 to.

At operation 905, serving network node 103a requests a material map from its neighbor network nodes. This can be done for example as an entry to a neighbor relations table (NRT) or on a request-response basis using the X2 protocol.

At operation 907, serving network node 103a predicts future mobility patterns of communication device 101 based on historical mobility patterns. The prediction may be based on one or both of the following: (1) Historical communication device 101 location updates that serving network node 103a may have from measurement reports; and/or (2) historical communication device 101 location updates (on a cell granularity) that serving network node 103a may request from a mobility management node of the core network (e.g., a Mobility Management Entity (MME) in 4G or an Access and Mobility Management Function (AMF) in 5G).

At operation 909, serving network node 103a makes a selection of the best next hop that, in addition to reference signal measurements, is based on a rating of the absorption of materials in path of communication device 101 from neighboring a neighboring network node.

At operation 911, network node 103a signals a handover request to network node 103b.

At operation 913, responsive to the receiving the handover request, network node 103b performs an admission control procedure.

At operation 915, network node 103b signals a message towards network node 103a including a handover request acknowledgement.

At operation 917, handover initiation is signalled from network node 103b to communication device 101.

At operation 919, responsive to handover initiation 917, handover execution is completed.

In contrast, currently the handover decision process is based on measurement reports about the serving RBS (sRBS) and a target RBS (tRBS) provided by a communication device to the sRBS. When the signal strength of the tRBS becomes greater than one of sRBS and the difference is greater than an offset (known as A3 offset), then the sRBS decides to handover the communication device to the tRBS, as long as this difference lasts longer than a prespecified time (e.g., also known as time to trigger or TIT (see e.g., https://www.netmanias.com/en/post/techdocs/6224/emm-handover-lte/emm-procedure-6-handover-without-tau-part-1-overview-of-Ite-handover).

In some embodiments of the present disclosure, an example process for a handover decision is as follows:

First, use the legacy algorithm for all neighboring RBSs that communication device 101 has provided a measurement report for, and sort all RBSs by descending order, based on the difference of reference signal. Rule out all those RBSs that have a difference below A3 offset and/or the difference lasts for less than TTT.

Subsequently, calculate occlusion quality for the RBSs that cover the predicted mobility path of communication device 101. Rule out all those RBSs that are not in the mobility path of communication device 101 and will not be able to provide coverage.

This results in two lists of neighboring RBSs to sRBS (e.g., referred to below as list1 and list2). Then, in the following example algorithm, indexing of an array starts from 0:

```
indexed_RBS.init( )
For every RBS a in list1:
  if (list2.exists(a)) {
    index_element=bias1*(list1.index(a))/list1.size //Get index of a in list
    1
    index_element+=bias2*(list2.index(a))/list2.size
    indexed_RBS.add(<a, index_element>)
  }
Sort indexed_RBS by index_element by descending order
Return indexed_RBS[0]
```

In this example algorithm, bias coefficients are included (e.g., if legacy selection I preferred over occlusion quality. If there is no bias, bias1=bias2=0.5. If RSRP measurement reports are to be favored, then for example bias1=0.75 and bias2=0.25).

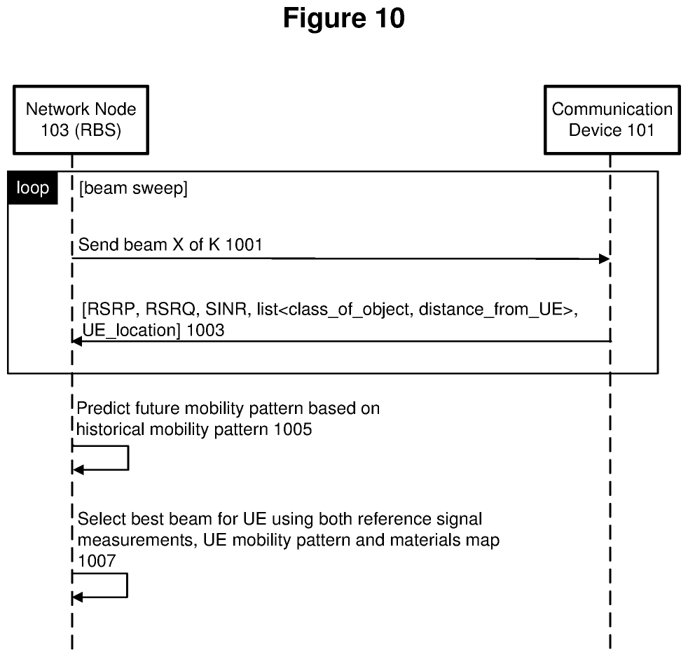

An example embodiment illustrating a beam selection process using a composite description (e.g., a material map) is now discussed. FIG. 10 illustrates a signalling diagram for beam selection based on reference signal measurements and materials maps, in accordance with some embodiments of the present disclosure. In this embodiment, and for the duration of the beam sweep, network node 103 sends 1001 Send beam X of K to communication device 101; and communication device 101 sends 1003 reference signal measurements for every beam received augmented by assorted environment measurements described herein. Based on the location of communication device 101 and the predicted mobility pattern retrieved 1005 as discussed herein, network node 103 makes a decision 1007 to allocate a beam to communication device 101. This beam may not be the one with the best reference signal measurement, but the one with both the best reference signal measurement and less chance of signal degradation due to object occlusion. A similar decision algorithm as to the decision algorithm discussed above with reference to the example embodiment for a handover process may also be used in this embodiment.

Alternatively, in another embodiment, beam sweeping is skipped altogether and only the material map and current communication device 101 location is used as basis for choosing a beam. In this embodiment, a beam is chosen based on the lowest signal degradation rating, after identifying the communication device 101 position (e.g., through transmission of a reference signal measurement by any beam that can be received by communication device 101, as shown in FIG. 10, or using position approach as illustrated in FIG. 7).

Various embodiments of the present disclosure may have potential advantages of not violating privacy concerns when a communication device reveals its location. In some embodiments, the communication device does not necessarily need to report the objects it senses/detects, but rather the communication device can use a symbolic graph, e.g., as illustrated in FIG. 8, in order to store only signal absorption capabilities around a location.

Additionally, or alternatively, a communication device can opt-in/out of this process, as the transmission of SINR, list<class_of_object, distance_from_UE>, UE_location are transmitted on discretion of the communication device.

Additionally, or alternatively, based on a geo-location, bounding boxes can be enforced by the operator to exclude areas (such military zones) from the method of the present disclosure.

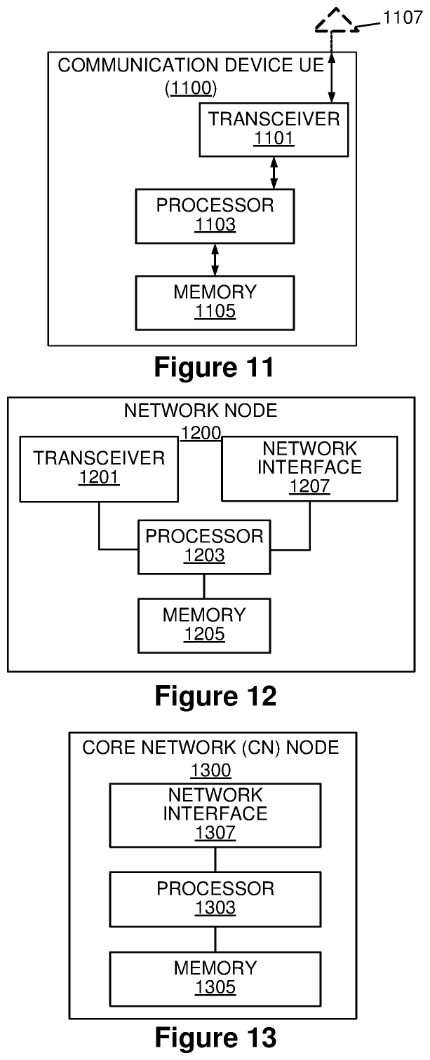

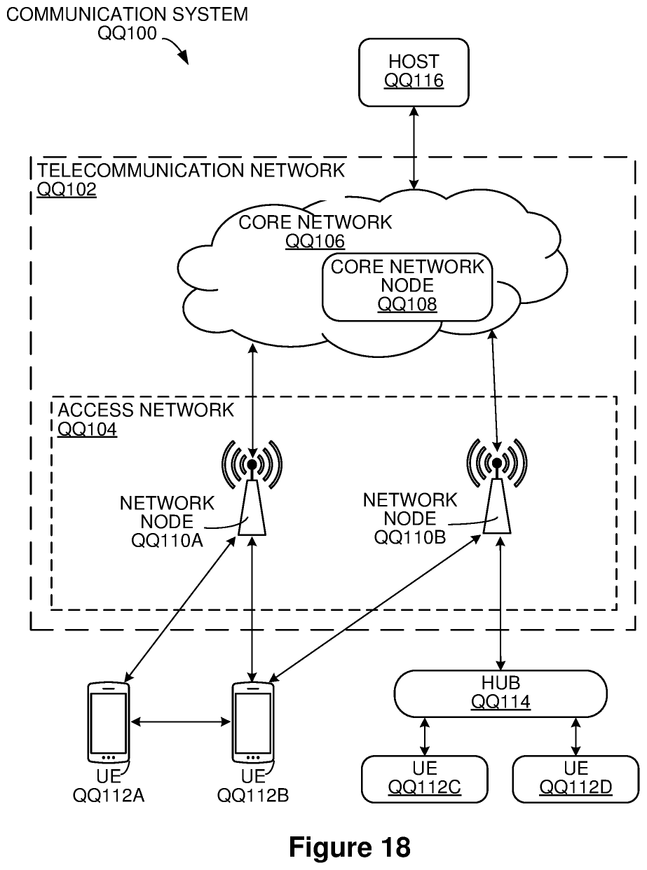

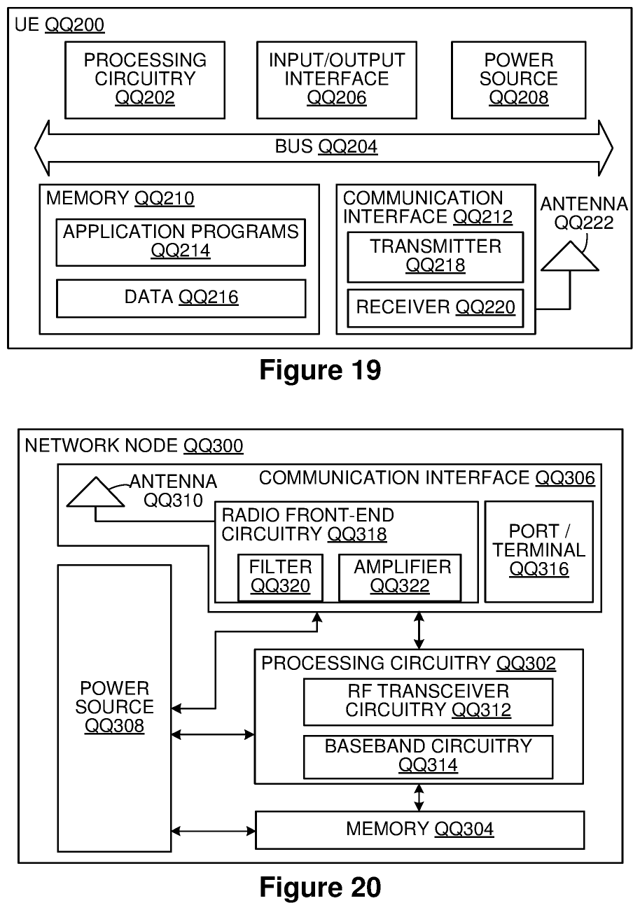

FIG. 11 is a block diagram illustrating elements of a communication device UE 1100 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 1100 may be provided, for example, as discussed below with respect to wireless devices UE QQ112A, UE QQ112B, and wired or wireless devices UE QQ112C, UE QQ112D of FIG. 18, UE QQ200 of FIG. 19, and virtualization hardware QQ504 and virtual machines QQ508A, QQ508B of FIG. 22, all of which should be considered interchangeable in the examples and embodiments described herein and be within the intended scope of this disclosure, unless otherwise noted.) As shown, communication device UE may include an antenna 1107 (e.g., corresponding to antenna QQ222 of FIG. 19), and transceiver circuitry 1101 (also referred to as a transceiver, e.g., corresponding to interface QQ212 of FIG. 19 having transmitter QQ218 and receiver QQ220) including a transmitter and a receiver configured to provide uplink and downlink radio communications with a base station(s) (e.g., corresponding to network node QQ110A, QQ110B of FIG. 18, network node QQ300 of FIG. 20 also referred to as a RAN node or radio base station (RBS)) of a radio access network. Communication device UE may also include processing circuitry 1103 (also referred to as a processor, e.g., corresponding to processing circuitry QQ202 of FIG. 19, and control system QQ512 of FIG. 22) coupled to the transceiver circuitry, and memory circuitry 1105 (also referred to as memory, e.g., corresponding to memory QQ210 of FIG. 18) coupled to the processing circuitry. The memory circuitry 1105 may include computer readable program code that when executed by the processing circuitry 1103 causes the processing circuitry to perform operations according to embodiments disclosed herein. According to other embodiments, processing circuitry 1103 may be defined to include memory so that separate memory circuitry is not required. Communication device UE may also include an interface (such as a user interface) coupled with processing circuitry 1103, and/or communication device UE may be incorporated in a vehicle.

As discussed herein, operations of communication device UE may be performed by processing circuitry 1103 and/or transceiver circuitry 1101. For example, processing circuitry 1103 may control transceiver circuitry 1101 to transmit communications through transceiver circuitry 1101 over a radio interface to a radio access network node (also referred to as a base station) and/or to receive communications through transceiver circuitry 1101 from a RAN node over a radio interface. Moreover, modules may be stored in memory circuitry 1105, and these modules may provide instructions so that when instructions of a module are executed by processing circuitry 1103, processing circuitry 1103 performs respective operations (e.g., operations discussed below with respect to Example Embodiments relating to communication devices). According to some embodiments, a communication device UE 1100 and/or an element(s)/function(s) thereof may be embodied as a virtual node/nodes and/or a virtual machine/machines.

FIG. 12 is a block diagram illustrating elements of a radio access network RAN node 700 (also referred to as a network node, base station, radio base station, eNodeB/eNB, gNodeB/gNB, etc.) of a Radio Access Network (RAN) configured to provide cellular communication according to embodiments of inventive concepts. (RAN node 1200 may be provided, for example, as discussed below with respect to network node QQ110A, QQ110B of FIG. 18, network node QQ300 of FIG. 20, hardware QQ504 and/or virtual machine QQ508A, QQ508B of FIG. 22, all of which should be considered interchangeable in the examples and embodiments described herein and be within the intended scope of this disclosure, unless otherwise noted.) As shown, the RAN node may include transceiver circuitry 1201 (also referred to as a transceiver, e.g., corresponding to portions of RF transceiver circuitry QQ312 and radio front end circuitry QQ318 of FIG. 20) including a transmitter and a receiver configured to provide uplink and downlink radio communications with mobile terminals. The RAN node may include network interface circuitry 1207 (also referred to as a network interface, e.g., corresponding to portions of communication interface QQ306 of FIG. 20) configured to provide communications with other nodes (e.g., with other base stations) of the RAN and/or core network CN. The network node may also include processing circuitry 1203 (also referred to as a processor, e.g., corresponding to processing circuitry QQ302 of FIG. 20) coupled to the transceiver circuitry, and memory circuitry 1205 (also referred to as memory, e.g., corresponding to memory QQ304 of FIG. 20) coupled to the processing circuitry. The memory circuitry 1205 may include computer readable program code that when executed by the processing circuitry 1203 causes the processing circuitry to perform operations according to embodiments disclosed herein. According to other embodiments, processing circuitry 1203 may be defined to include memory so that a separate memory circuitry is not required.

As discussed herein, operations of the RAN node may be performed by processing circuitry 1203, network interface 1207, and/or transceiver 1201. For example, processing circuitry 1203 may control transceiver 1201 to transmit downlink communications through transceiver 1201 over a radio interface to one or more mobile terminals UEs and/or to receive uplink communications through transceiver 1201 from one or more mobile terminals UEs over a radio interface. Similarly, processing circuitry 1203 may control network interface 1207 to transmit communications through network interface 1207 to one or more other network nodes and/or to receive communications through network interface from one or more other network nodes. Moreover, modules may be stored in memory 1205, and these modules may provide instructions so that when instructions of a module are executed by processing circuitry 1203, processing circuitry 1203 performs respective operations (e.g., operations discussed below with respect to Example Embodiments relating to network nodes). According to some embodiments, RAN node 1200 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

FIG. 13 is a block diagram illustrating elements of a core network (CN) node (e.g., an SMF (session management function) node, an AMF (access and mobility management function) node, etc.) of a communication network configured to provide cellular communication according to embodiments of inventive concepts. (CN node 1300 may be provided, for example, as discussed below with respect to core network node QQ108 of FIG. 18, hardware QQ504 or virtual machine QQ508A, QQ508B of FIG. 22, all of which should be considered interchangeable in the examples and embodiments described herein and be within the intended scope of this disclosure, unless otherwise noted). As shown, the CN node may include network interface circuitry 1307 configured to provide communications with other nodes of the core network and/or the radio access network RAN. The CN node may also include a processing circuitry 1303 (also referred to as a processor,) coupled to the network interface circuitry, and memory circuitry 1305 (also referred to as memory) coupled to the processing circuitry. The memory circuitry 1305 may include computer readable program code that when executed by the processing circuitry 1303 causes the processing circuitry to perform operations according to embodiments disclosed herein. According to other embodiments, processing circuitry 1303 may be defined to include memory so that a separate memory circuitry is not required.

As discussed herein, operations of the CN node may be performed by processing circuitry 1303 and/or network interface circuitry 1307. For example, processing circuitry 1303 may control network interface circuitry 1307 to transmit communications through network interface circuitry 1307 to one or more other network nodes and/or to receive communications through network interface circuitry from one or more other network nodes. Moreover, modules may be stored in memory 1305, and these modules may provide instructions so that when instructions of a module are executed by processing circuitry 1303, processing circuitry 1303 performs respective operations. According to some embodiments, CN node 1300 and/or an element(s)/function(s) thereof may be embodied as a virtual node/nodes and/or a virtual machine/machines.

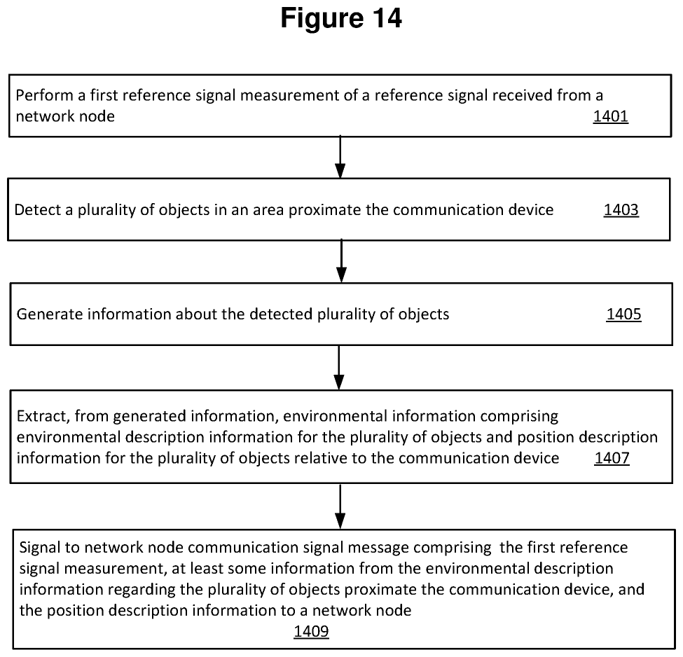

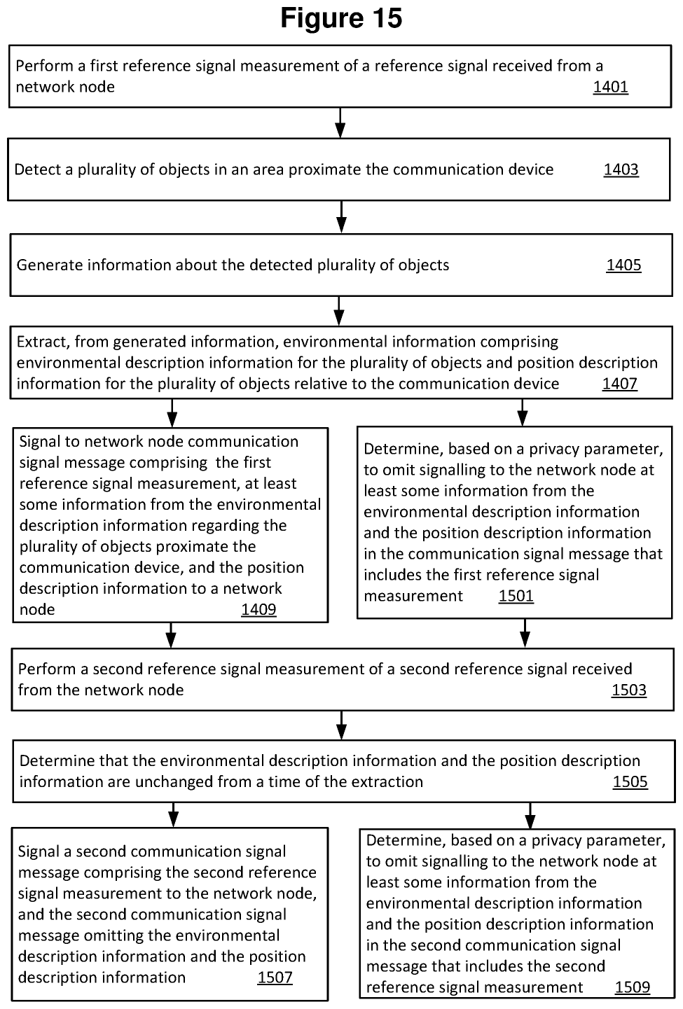

In the description that follows, while the communication device may be any of the communication device 1100, wireless device QQ112A, QQ112B, wired or wireless devices UE QQ112C, UE QQ112D, UE QQ200, virtualization hardware QQ504, virtual machines QQ508A, QQ508B, or UE QQ606, the communication device 1100 shall be used to describe the functionality of the operations of the communication device. Operations of the communication device 1100 (implemented using the structure of the block diagram of FIG. 11) will now be discussed with reference to the flow charts of FIGS. 14 and 15 according to some embodiments of inventive concepts. For example, modules may be stored in memory 1105 of FIG. 11, and these modules may provide instructions so that when the instructions of a module are executed by respective communication device processing circuitry 1103, processing circuitry 1103 performs respective operations of the flow charts.

Referring first to FIG. 14, a method performed by a communication device (101, 1100) in a communication network for augmenting a communication signal message with environmental information relative to the communication device is provided. The method includes performing (1401) a first reference signal measurement of a reference signal received from a network node. The method further includes, responsive to the performing, detecting (1403) a plurality of objects in an area proximate the communication device. The method further includes generating (1405) information about the detected plurality of objects. The method further includes extracting (1407), from the generated information, the environmental information comprising an environmental description information for the plurality of objects and a position description information for the plurality of objects relative to the communication device. The method further includes signalling (1409) to the network node the communication signal message comprising the first reference signal measurement, at least some information from the environmental description information regarding the plurality of objects in an area proximate the communication device, and the position description information.

Referring now to FIG. 15, in some embodiments, the method further includes determining (1501), based on a privacy parameter, to omit signalling to the network node at least some information from the environmental description information and the position description information in the communication signal message that includes the first reference signal measurement.

In some embodiments, the detecting (1403) is performed with a sensor of the communication device, the sensor comprising at least one of a camera, a light detection and ranging, a visual objection detector, and a location positioning equipment. The location positioning equipment includes, without limitation, satellite-based positioning and using audio waves as discussed herein.

In some embodiments, the environmental description information includes information related to a class, a dimension, and a material composition of each object in the detected plurality of objects.

In some embodiments, the position description information includes at least one of a distance and a geographic direction of each object in the detected plurality of objects relative to the communication device.

In some embodiments, the method further includes performing (1503) a second reference signal measurement of a second reference signal received from the network node; and determining (1505) that the environmental description information and the position description information are unchanged from a time of the extracting (1407).

In some embodiments, the method further includes signalling (1507) a second communication signal message including the second reference signal measurement to the network node, and the second communication signal message omitting the environmental description information and the position description information.

In some embodiments, the method further includes determining (1509), based on a privacy parameter, to omit signalling to the network node the environmental description information and the position description information in the second communication signal message that includes the second reference signal measurement.

In some embodiments, the environmental description information comprises information related to a dimension and a signal absorption metric of each object in the detected plurality of objects.

In some embodiments, the position description information includes one of a Euclidean distance, a haversine distance, and a cosine similarity of [latitude. longitude] vectors of each object in the detected plurality of objects relative to the communication device.

In some embodiments, the communication device is one of mobile device, a cellular telephone, and a user equipment, UE.

In some embodiments, the communication network is one of a fourth generation, 4G, mobile network and a fifth generation, 5G, mobile network.

Various operations from the flow chart of FIG. 15 may be optional with respect to some embodiments of a method performed by a communication device. For example, operations of blocks 1501-1509 of FIG. 15 may be optional.

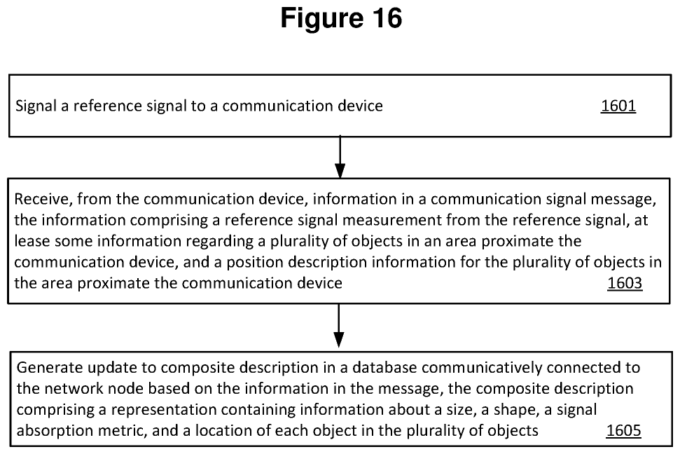

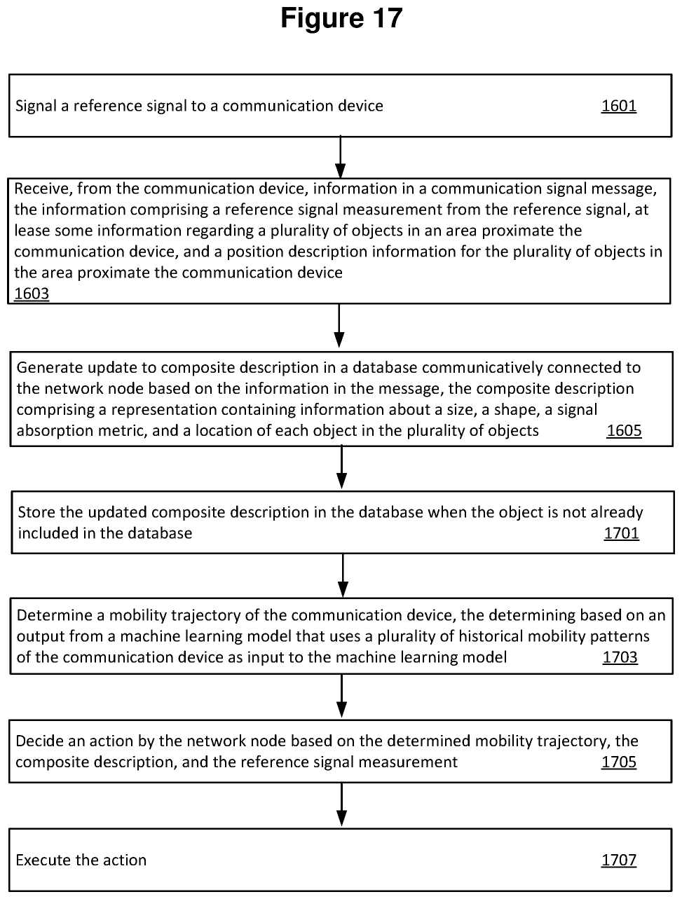

Operations of a network node 103 (implemented using the structure of FIG. 12) will now be discussed with reference to the flow chart of FIGS. 16 and 17 according to embodiments of the present disclosure. In the description that follows, while the network node may be any of the RAN node 1200, network node QQ110A, QQ110B, QQ300, QQ606, hardware QQ504, or virtual machine QQ508A, QQ508B, the RAN node 1200 shall be used to describe the functionality of the operations of the network node. Operations of the RAN node 1200 (implemented using the structure of FIG. 12) will now be discussed with reference to the flow charts of FIGS. 16 and 17 according to some embodiments of inventive concepts. For example, modules may be stored in memory 1205 of FIG. 12, and these modules may provide instructions so that when the instructions of a module are executed by respective RAN node processing circuitry 1203, processing circuitry 1203 performs respective operations of the flow charts.

Referring first to FIG. 16, a method performed by a network node (103, 1200) in a communication network for generating an update to a composite description of an environment proximate a communication device is provided. The method includes signalling (1601) a reference signal to the communication device. The method further includes receiving (1603), from the communication device, information in a communication signal message. The information includes a reference signal measurement from the reference signal, at least some information regarding a plurality of objects in an area proximate the communication device, and a position description information for the plurality of objects in the area proximate the communication device. The method further includes generating (1605) the update to the composite description in a database communicatively connected to the network node based on the information in the message. The composite description includes a representation containing information about a size, a shape, a signal absorption metric, and a location of each object in the plurality of objects.

In some embodiments, the environmental description information includes information related to a class, a dimension, and a material composition of each object in the detected plurality of objects.

In some embodiments, the position description information includes at least one of a distance and a geographic direction of each object in the detected plurality of objects relative to the communication device.

In some embodiments, the generating (1605) the update to the composite description includes an extraction from the information in the message of properties of each object in the plurality of objects.

In some embodiments, the extraction includes for each object in the plurality of objects: calculating a first signal absorption metric from the material composition of the object; identifying a second signal absorption metric from a class of the object; and finding the location of the object.

Referring now to FIG. 17, in some embodiments, the method further includes storing (1701) the updated composite description in the database when the object is not already included in the database.

In some embodiments, the composite description is in the form of a symbolic graph.

In some embodiments the method further includes determining (1703) a mobility trajectory of the communication device, the determining based on an output from a machine learning model that uses a plurality of historical mobility patterns of the communication device as input to the machine learning model; and deciding (1705) an action by the network node based on the determined mobility trajectory, the composite description, and the reference signal measurement.

In some embodiments, the action is selection of a neighboring network node to handover the communication device.

In some embodiments, the action is an allocation of a beam for the communication device. The allocation of the beam is from an antenna of the network node for the communication device (e.g., during a beam sweeping process being done for a beamforming-capable multiple input multiple output (MIMO) antenna).

In some embodiments, the method further includes executing (1707) the action.

In some embodiments, the network node includes a radio base station, the radio base station comprising one of an e-NodeB and a g-NodeB.

Various operations from the flow chart of FIG. 17 may be optional with respect to some embodiments of a method performed by a network node. For example, operations of blocks 1701-1707 of FIG. 17 may be optional.

Although communication device 1100 and network node 1200 are illustrated in the example block diagrams of FIGS. 11 and 12 each may represent a device that includes the illustrated combination of hardware components, other embodiments may comprise communication devices and network nodes with different combinations of components. It is to be understood that each of a communication device and a network node comprise any suitable combination of hardware and/or software needed to perform the tasks, features, functions, and methods disclosed herein. Moreover, while the components of each of a communication device and a network node are depicted as single boxes located within a larger box, or nested within multiple boxes, in practice, each device may comprise multiple different physical components that make up a single illustrated component (e.g., a memory may comprise multiple separate hard drives as well as multiple RAM modules).

FIG. 18 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 18 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

FIG. 19 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 19. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 19.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 20 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 20 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

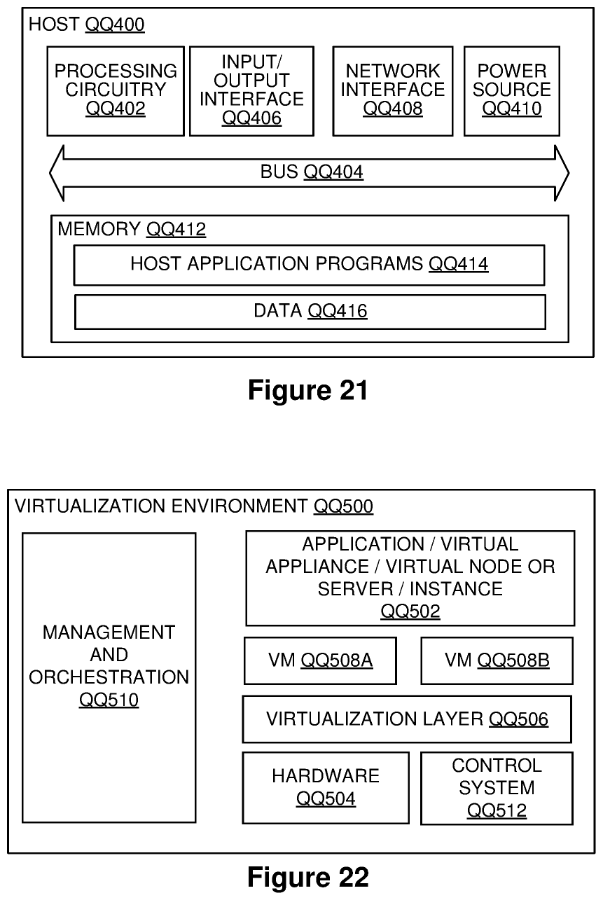

FIG. 21 is a block diagram of a host QQ400, which may be an embodiment of the host QQ116 of FIG. 18, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 22 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a communication device in a communication network for augmenting a communication signal message with environmental information relative to the communication device, the method comprising:
performing a first reference signal measurement of a reference signal received from a network node;
responsive to the performing, detecting a plurality of objects in an area proximate the communication device;
generating information about the detected plurality of objects;
extracting, from the generated information, the environmental information comprising an environmental description information for the plurality of objects and a position description information for the plurality of objects relative to the communication device; and
signalling to the network node the communication signal message comprising the first reference signal measurement, at least some information from the environmental description information regarding the plurality of objects in an area proximate the communication device, and the position description information.

2. The method of claim 1, further comprising:
determining, based on a privacy parameter, to omit signalling to the network node at least some information from the environmental description information and the position description information in the communication signal message that includes the first reference signal measurement.

3. The method of claim 1, wherein the detecting is performed with a sensor of the communication device, the sensor comprising at least one of a camera, a light detection and ranging, a visual objection detector, and a location positioning equipment.

4. The method of claim 1, wherein the environmental description information comprises information related to a class, a dimension, and a material composition of each object in the detected plurality of objects.

5. The method of claim 1, wherein the position description information comprises at least one of a distance and a geographic direction of each object in the detected plurality of objects relative to the communication device.

6. The method of claim 1, further comprising:
performing a second reference signal measurement of a second reference signal received from the network node; and
determining that the environmental description information and the position description information are unchanged from a time of the extracting.

7. The method of claim 6, further comprising:
signalling a second communication signal message comprising the second reference signal measurement to the network node, and the second communication signal message omitting the environmental description information and the position description information.

8. The method of claim 6, further comprising:
determining, based on a privacy parameter, to omit signalling to the network node the environmental description information and the position description information in the second communication signal message that includes the second reference signal measurement.

9. The method of claim 1, wherein the environmental description information comprises information related to a dimension and a signal absorption metric of each object in the detected plurality of objects.

10. The method of claim 1, wherein the position description information comprises one of a Euclidean distance, a haversine distance, and a cosine similarity of vectors of each object in the detected plurality of objects relative to the communication device.

11. The method of claim 1, wherein the communication device is one of mobile device, a cellular telephone, and a user equipment, UE.

12. The method of claim 1, wherein the communication network is one of a fourth generation, 4G, mobile network and a fifth generation, 5G, mobile network.

13. A communication device in a communication network for augmenting a communication signal message with environmental information relative to the communication device, the communication device comprising:
at least one processor;
at least one memory connected to the at least one processor and storing program code that is executed by the at least one processor to perform operations comprising:
perform a first reference signal measurement of a reference signal received from a network node;
responsive to the perform, detect a plurality of objects in an area proximate the communication device;
generate information about the detected plurality of objects;
extract, from the generated information, the environment information comprising an environmental description information for the plurality of objects and a position description information for the plurality of objects relative to the communication device; and
signal to the network node the communication signal message comprising the first reference signal measurement, at least some information from the environmental description information regarding the plurality of objects in an area proximate the communication device, and the position description information.

14. (canceled)

15. A communication device in a communication network for augmenting a communication signal message with environmental information relative to the communication device, the communication device adapted to perform operations comprising:
perform a first reference signal measurement of a reference signal received from a network node;
responsive to the perform, detect a plurality of objects in an area proximate the communication device;
generate information about the detected plurality of objects;
extract, from the generated information, the environmental information comprising an environmental description information for the plurality of objects and a position description information for the plurality of objects relative to the communication device; and
signal to the network node the communication signal message comprising the first reference signal measurement, at least some information from the environmental description information regarding the plurality of objects in an area proximate the communication device, and the position description information.

16.-40. (canceled)
